(19) United States
(12) Patent Application Publication
(10) Pub. No.: US 2008/0183988 A1
(43) Pub. Date: Jul. 31, 2008

(54) Application Integrated Storage System Volume Copy and Remote Volume Mirror

(76) Inventor: Yanling Qi, Austin, TX (US)

Correspondence Address: LSI CORPORATION, 1621 BARBER LANE, MS: D-106, MILPITAS, CA, 95035, US

(21) Appl. No.: 11/668,989

(22) Filed: Jan. 30, 2007

(51) Int. Cl. G06F 12/16

(52) U.S. Cl. 711/162; 711/E12.103

(57) ABSTRACT

Systems, devices and methods are described for copying used data block within a source volume to a target volume. A copy manager is provided on a host system for coordinating external copy requests originating from external sources. An application adapter layer is provided that provides lists of the blocks that are occupied on the source volume by the specific applications. The occupied block lists is forwarded along with the copy requests to a storage system adapter layer. The storage system copies only the data that are written in the occupied blocks of the source volume to the target volume. During the copy operation, all I/O requests are paused and resumed after the copy operation is complete.

### BACKGROUND

A. Technical Field

This invention relates to the management of storage systems, and more particularly, to a method and system for providing volume copying of storage systems.

B. Background of the Invention

The application and importance of large data storage systems is well known. These storage systems typically include multiple disk drives on which large volumes of data are stored. This data is usually stored in addressable blocks or location within the disk drives so that data may be written to or retrieved from the drive based on a location associated with the data.

Oftentimes, the storage system does not use contiguous blocks of memories to store data, which results in the data being interspersed across a disk drive or drives. As a result, a disk drive or drives may have empty storage locations spread throughout its memory in which blocks of memories are unused.

Storage systems have numerous features and functionalities that allow a user to manage the storage of data within the system. A “volume copy” command is a feature that allows data to be moved internally within the storage system without using any I/O bandwidth of its host system. Volume copy may also be known as “volume clone,” “hardware disk-to-disk copy,” or “hardware disk-to-disk clone” in which data stored in a source storage volume is copied to a target storage volume.

During a volume copy operation, a copy pair includes the source volume and the target volume, both of which are typically located on the same storage array. The source volume accepts host I/O and stores the corresponding data. The source volume can be a standard volume, snapshot volume, base volume of a snapshot volume, or a Remote Volume Mirror primary volume. A volume copy command may be used to back up data, copy data from volume groups that use smaller capacity drives to volume groups using greater capacity drives, or to restore snapshot volume data to the associated base volume. This command could also be used to move data from one set of disk drives to another for hardware upgrades or data migration.

The volume copy feature may be managed within the storage system by various devices. For example, a volume copy command may be managed by one or more storage controllers within the storage system. In addition, the process of a volume copy operation may be transparent to host machines and applications depending on the storage system.

Remote volume mirror, also known as peer-to-peer mirror or just mirroring, is an inter-storage system operation and is generally used for online, real-time replication of data between storage arrays over a remote distance. In the event of a disaster or a failure of one storage array, remote volume mirror allows a second storage array to take over responsibility for computing services.

In the process of remote volume mirror, a mirrored volume pair is created, including a primary volume at the primary storage array and a secondary volume at a secondary, remotely located storage array. The primary volume is the volume that accepts host I/O and stores corresponding data. When a mirror relationship is initially created, data from the primary volume is copied in its entirety to the secondary volume. This process is known as full synchronization and is generally directed by the controller of the primary volume. After the two volume's data are synchronized, any new update on the primary will be mirrored to its secondary volume.

The process of a volume copy operation results in the content stored in the source volume being read and written to a target volume from the beginning to the end of that volume. Hence, after the copy operation is completed, the source volume and the target volume contain exactly same data block by block.

FIG. 1 depicts the operation of volume copy within a source volume 101 and a target volume 102. As explained above, the source volume 101 may have large amount of unused memory block 103 having no data. During the volume copy operation, entire source volume 101 is copied to the target volume. When a copy process is started, the storage system will start a long run task and perform a read operation(s) from the source volume and write to the target volume until all data are copied to the target volume. Accordingly, unused memory blocks within the source volume are also copied into the target volume, resulting in identical unused blocks of memory in that target volume.

One skilled in the art will recognize that copying large volumes of data between drives or arrays may consume a significant amount of the storage system internal bandwidth, CPU cycles, and physical memory. Additionally, this copying procedure may affect the time window of a target volume's availability. For example, if the copy operation is from one storage system to another storage system, copying unused data will consume the I/O bandwidth of the SAN (“Storage Area Network”), the IO bandwidth of both storage systems, and CPU cycles of both systems. More importantly, since the SAN bandwidth for inner storage systems connections is lower than that in the internal volume copy, the time period from starting a remote mirror operation to the pairs of volumes reaching synchronized state will take much longer.

A sample SAN configuration is shown in FIG. 2. The host systems 205 and the storage systems 203 are connected to SAN 202. Storage system 203 provides the data storage to host system 205 on the SAN 202. Network management system interfaces 204 such as Ethernet interfaces for out-band storage systems management are also provided within the storage systems 203. The host system 205 in the SAN configuration can either manage the storage system through IP network 201 (out-band management) or through the SAN 202 (in-band management)

In a large number of the cases, the application data is not fully occupied by the source volume and the copy operation copies unused blocks from the source volume to its target volume, often referred to as “copying nothing to nothing” within the art. As previously discussed, copying unused data costs storage system internal bandwidth, CPU cycles and system memory of both storage systems. If the remote volume mirror operation is through a low bandwidth and high latency SAN link, copying unused data to the remote storage system costs valuable SAN bandwidth and requires significant amounts of time to synchronize the primary and secondary volumes.

### SUMMARY OF THE INVENTION

The present invention provides methods, systems and devices for optimizing copying operations used to transfer and maintain blocks of data on a source volume to a target volume. In various embodiments of the invention, the source and the target volume are contained within a Storage Area Network environment.

In various embodiments of the invention, a copy manager is provided on a host system for coordinating external copy requests originating from external sources. The copy request may be in the format that specifies the storage system, source volume, target volume and a list of used data blocks. The copy manager may be configured to continuously check for the arrival of any copy request. After a copy request is received and processed, it is sent to the storage system's application adapter layer. The application adapter layer forwards the processed copy requests to application specific adapters such as adapter specific to the file system, database management software, web application server or logical volume manager. The application specific adapters are provided to perform the task of freezing their respective I/O requests on arrival of any copy request. The application specific adapters may also perform the task of flushing the application's operating system cache buffers in order to make the application's data consistent on the storage volume.

The application adapter layer comprises application specific adapters that provide lists of the blocks that are occupied on the source volume by the specific applications. The application specific adapter sends a notification in terms of a ready-to-copy response with a used block list to the adapter layer. This response is further forwarded to a storage system adapter layer. The storage system copies only the data that are written in the occupied blocks to the target volume. Thereafter, one cycle of copy operation is completed and the application adapter layer is notified about the copy completion status.

In various embodiments of the present invention, the used block list may be provided in the form of a list containing logical block addresses (“LBAs”) of the source volume and the “length” of the data that is stored in the used blocks. The length of the data may be calculated by counting the total number of blocks from the LBA wherein each block of the length stores the application data.

In other embodiments, the used blocks may be specified in the form of bits. A ‘1’ stored in the bitmap may indicate that the corresponding block in the source volume is used or occupied and a ‘0’ stored in the bitmap may indicate that the corresponding block in the source volume is unused or not occupied. Further, the block address may be identified by analyzing the positions of the bits (0 or 1) stored in the bitmap.

The time consumed by the volume copy process is reduced and the internal bandwidth of the storage system, SAN bandwidth and storage system resource is further optimized as compared to the traditional volume copy process. As a result, the application availability is increased and the I/O performance of the storage system is improved. Other problems associated with “copying nothing to nothing” are also addressed because of the more efficient copying functionality.

Other objects, features and advantages of the invention will be apparent from the drawings, and from the detailed description that follows below.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 illustrates a copy operation of used and unused capacity from a source volume to a target volume.

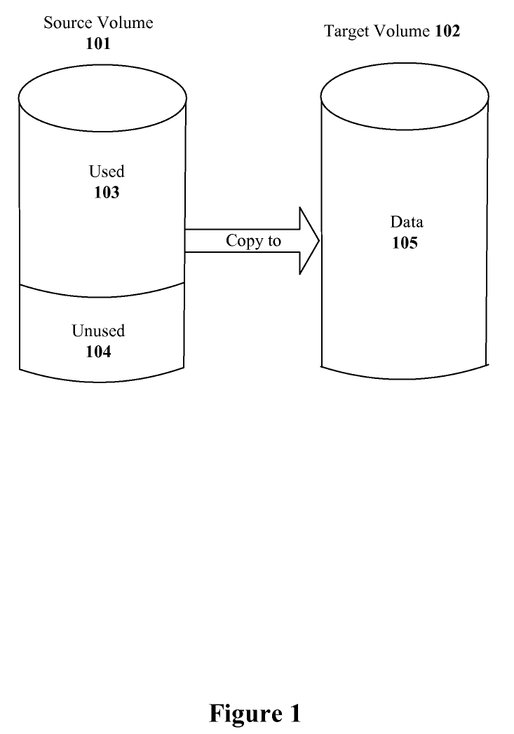

FIG. 2 illustrates storage area network configurations.

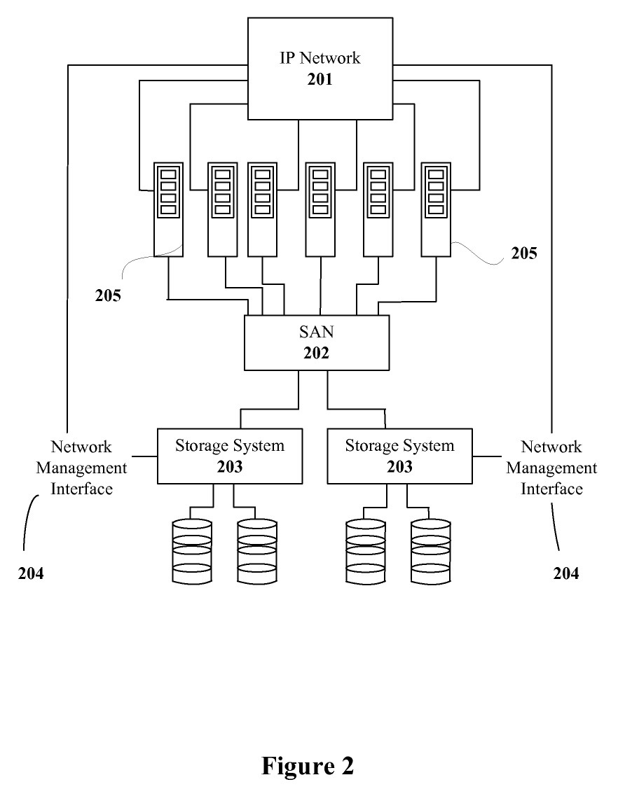

FIG. 3 is a flowchart for copying used blocks of source volume to a target volume according to various embodiments of the invention.

FIG. 4 is a block diagram of storage system adapter according to various embodiments of the invention.

FIG. 5 shows data storage structure of an exemplary file system.

FIG. 6 is a sequence diagram of an integrated copy operation according to various embodiments of the invention.

### DETAILED DESCRIPTION OF THE PREFERRED EMBODIMENTS

Systems, devices and methods are described for copying used data block within a source volume to a target volume. A copy manager is provided on a host system for coordinating external copy requests originating from external sources. An application adapter layer is provided that provides lists of the blocks that are occupied on the source volume by the specific applications. The occupied block lists is forwarded along with the copy requests to a storage system adapter layer. The storage system copies only the data that are written in the occupied blocks of the source volume to the target volume. During the copy operation, all I/O requests are paused and resumed after the copy operation is complete.

In the following description, for purpose of explanation, specific details are set forth in order to provide an understanding of the invention. It will be apparent, however, to one skilled in the art that the invention may be practiced without these details. One skilled in the art will recognize that embodiments of the present invention, some of which are described below, may be incorporated into a number of different systems and devices. The embodiments of the present invention may also be present in software, hardware or firmware. Structures and devices shown below in block diagram are illustrative of exemplary embodiments of the invention and are meant to avoid obscuring the invention. Furthermore, connections between components and/or modules within the figures are not intended to be limited to direct connections. Rather, data between these components and modules may be modified, re-formatted or otherwise changed by intermediary components and modules.

Reference in the specification to “one embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

A. Overview

A copy manger is provided within a storage system that manages external copy requests. In various embodiments of the invention, the copy manager may be a software component that receives copy requests such as a request to replicate application data in the same storage system or a request to clone the application data from one storage system to another storage system (remote mirror or remote copy). These external copy requests may be originated from an external copy requester and may also contain application information such as file system replication, database replication or logical volume group replication of a logical volume manager.

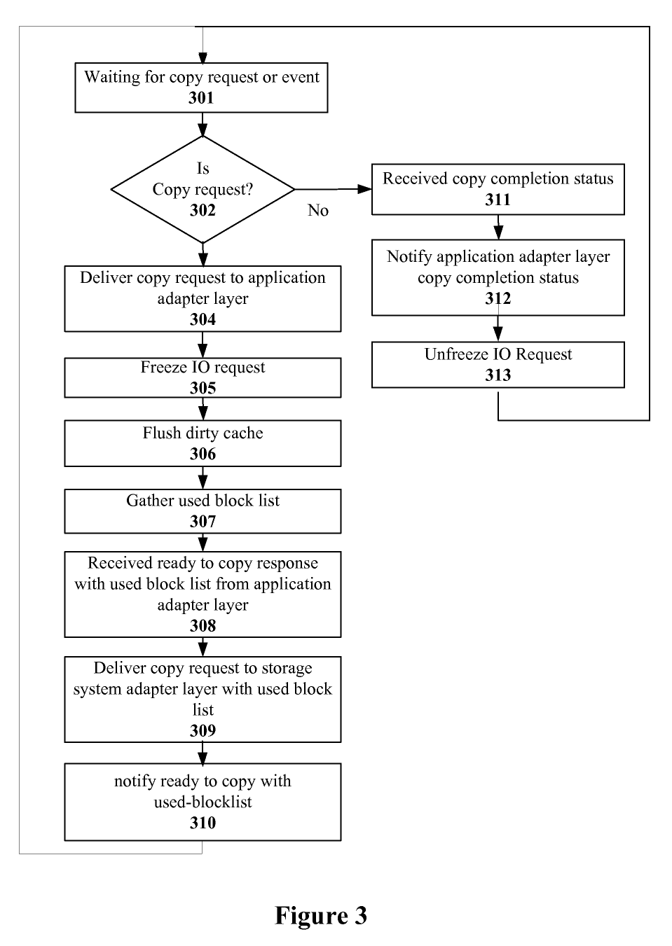

FIG. 3 illustrates an exemplary method of copying used data blocks within a source volume onto a target volume according to various embodiments of the invention. Initially, the copy manager waits for an external copy request or event to be received 301. The copy manager continuously checks for the arrival of such a copy requests 302 from commands received from either internal or external locations. After a copy request arrives and is identified, the copy manager processes the copy request and delivers the processed request to an application adapter layer 304. Based on application information within the request, the application adapter layer forwards the copy request to one or more application specific adapters such as adapter specific for file system, database management software, web application server or logical volume manager. During the copy process, the storage system prioritizes its task and may give the host I/O request higher priority. Before the copy process is completed, host I/O requests sent to the target volume are rejected to prevent data corruptions. The write I/O requests to the source volume are also usually not allowed.

In step 305, the application specific adapters freeze their respective I/O requests. In step 306, the application specific adapters flush the application's OS cache buffers in order to make application's data consistent on a storage volume. The used block list of the source storage volume is gathered by the application specific adapter in step 307 and the application specific adapter notifies the adapter layer of ready-to-copy response with used block list in step 308. Steps 305 to 308 are used for preparation of application specific copy requests, performed by the application adapter layer.

In step 309 the prepared or processed application specific copy request and the list of used blocks are delivered to a storage system adapter. The used block list is read and the storage system adapter layer sends a notification that it is ready to copy the contents written in those used block lists 310.

Thereafter, one cycle of the copy operation is completed and the copy manager again waits for an external copy request or event that is to be received 301. If a copy request is received, then steps 304 to 310 are repeated, else a copy completion status is received from the copy manger 311 and the application adapter layer is notified about the copy completion status 312. Subsequently, the I/O request is thawed by the application adapter layer 313.

B. Storage System Adapter

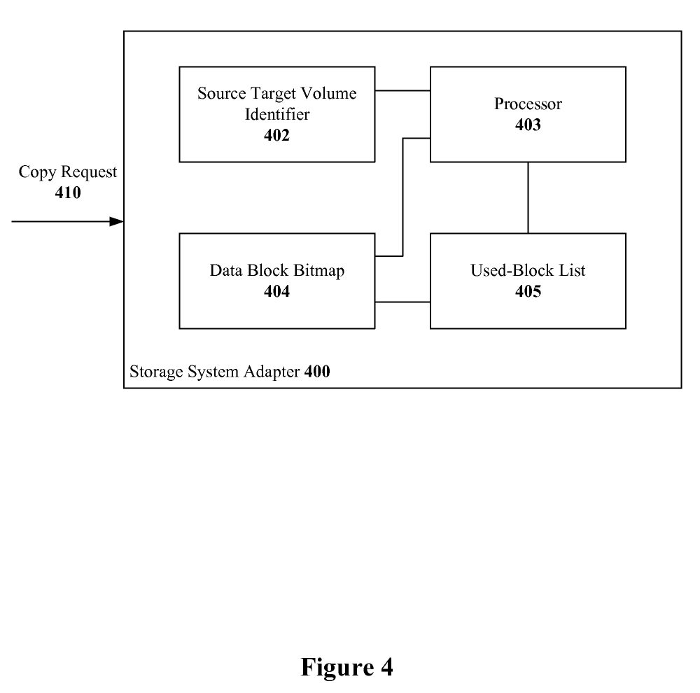

FIG. 4 illustrates the storage system adapter 400 according to various embodiments of the invention. The storage system adapter 400 receives the copy request 410 being sent through external copy requesters. The copy request 410 may be in the format that specifies the storage system, source volume, target volume and a list of used data blocks. The storage system adapter 400 may comprise a source target volume identifier 402, a processor 403, a data block bitmap 404 and a used block list 405. The source target volume identifier 402 uniquely identifies the source volume and the target volume in a storage array or in different storage arrays if the copy request 410 is for remote-volume mirror.

In various embodiments of the present invention, the used block list 405 may be provided in the form of a list containing the list of the Logical Block Addresses (“LBAs”) of the source volume and the length of the data that is stored in that used block. The LBA and the length of the data may be provided by the processor 403. The length of the data may also be calculated by counting the total number of blocks from the LBA wherein each block of the length stores the application data.

In other embodiments, the used blocks may be specified by data block bitmap 404 in form of bits. A “1” stored in the data block bitmap 404 may indicate that the corresponding block in the source volume is used or occupied and a ‘0’ stored in the data block bitmap 404 may indicate that the corresponding block in the source volume is unused or not occupied. Further, the block address may be identified by analyzing the positions of the bits (0 or 1) stored in the bitmap 404.

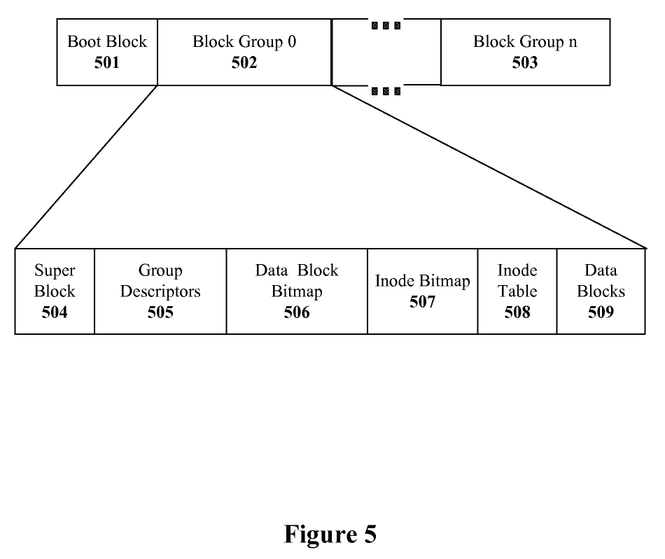

Each application can understand its internal data storage allocation and data storage structure. For instance as illustrated in FIG. 5, a data store layout of Linux ext2 file system are shown. The ext2 (second extended) file system specific application adapter will read its internal data store layout and reports its used data block list. Whenever a file system needs to read data from the block, it requests that its supporting device driver reads an integral number of blocks. The ext2 file system occupies a logical partition and divides it into Block Groups including a Boot Block 501 followed by ‘n’ number of Block groups from Block group 0 502 to Block Group N 503. Each block group duplicates critical information related to the integrity of the file system and holds real files and directories in form of blocks of information and data. This duplication is neccessary to recover the data in case of any disaster. Each bit within the block groups, represent the current state of a block within that group, where 1 indicates “used block” and 0 indicates “free block” or “available block”.

Each Block Group consists of different smaller groups in order to reduce internal fragmentation and the amount of headers involved in case of large amount of consecutive data to be read. The smaller groups include a Super Block 504, Group Descriptors 505, Data Block Bitmap 506, Inode Bitmap 507, Inode Table 508 and Data blocks 509.

The superblock 504 contains important information that is crucial to the booting of the operating system, which results in the generation of a backup copy in every block group of each block in the file system wherein the copy, which is found at the first block of the file system, is used in the booting. The group descriptor 505 stores the value of the data block bitmap 506, inode bitmap 507 and the start of the inode table 508 for every block group and these, in turn is stored in a group descriptor table.

The Inode Bitmap 507 works in a similar way as the Data Block Bitmap 506. Each bit represents an inode in the Inode Table 508. Each inode contains the information about a single physical file on the system. A file can be a directory, a socket, a buffer, character or block device, symbolic link or a regular file so an inode can be viewed as a block of information related to an entity, describing its location on a disk, its size and its owner.

There is one inode bitmap 507 per group and its location may be determined by reading its associated group descriptor 504. When the inode table 508 is created, all the reserved inodes are marked as used. The Inode Table 508 is used to keep track of files, file-location, size, type and access rights, which are stored in inodes. In the inode tables 508, all files are referenced by their inode number. There is one inode table 508 per group and it can be located by reading its associated group descriptor.

C. Integrated Copy Operation Process Illustration Through a Sequence Diagram

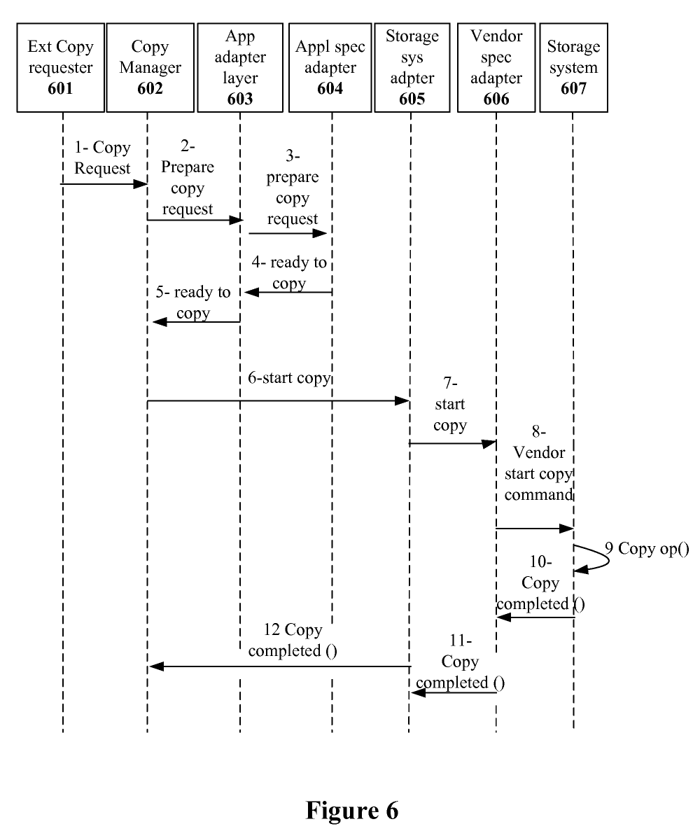

FIG. 6 is a sequence diagram of integrated copy operation according to various embodiments of the invention. An external copy requester 601 sends a copy request (step 1) to a copy manager 603. The copy request may be a kind of request to replicate application data in the same storage system or in an array of multiple storage systems. The copy manager manages or prepares the copy requests (step 2) and delivers the managed copy request to application adapter layer 603. The application adapter layer 603 comprises application specific adapters 604 specific for each application. The application adapter layer 603 prepares the copy request (step 3). The preparation of copy request may include the steps of freezing specific I/O requests by their respective application specific adapters 604, flushing the application's OS cache buffers in order to make application's data consistent on a storage volume, and generating a list of used blocks within the source storage volume.

The prepared application specific copy request and the list of used blocks are delivered to a storage system adapter 605. The application specific adapter 604 then notifies the application adapter layer that it is ready to copy (step 4). In other words, a ready-to-copy response is sent from the application specific adapter 604 to the application adapter layer 603. Similarly, a ready-to-copy response is sent from the application adapter layer 603 to the copy manager 602 (step 5). Along with the ready-to-copy responses, the list of used blocks is also sent. The used block list is read and the storage system adapter layer 605 starts copying the contents written in those used block lists (step 6).

An application specific adapter understands how to flush application's OS cache buffer to make application's data consistent on a storage volume before a copy operation, how to temporarily freeze application I/O requests, how to gather and report applications used data locations in a storage volume and how to gather and report application used data locations in a storage volume and finally resume application I/O request.

The storage system adapter may not know how to communicate with a vendor storage array system. Hence a vendor specific adapter may be provided to receive the respective copy request from a vendor. Storage system vendor specific adapters may be provided to translate the copy request from the storage system adapter to a vendor specific command of a vendor storage system. The command could be issued to a storage system's network management interfaces (out-band management) or through the host's SAN interface (in-band management).

The storage system adapter layer 605 is associated with multiple vendor specific adapters 606 that receives the respective copy request from a vendor and translates the copy request from the storage system adapter 605 to a vendor specific command of a vendor storage system 607. The storage system adapter 605 sends a start copy command (step 7) to the vendor specific adapter 606 along with the used block list. The content of the used block listed block list is read and vendor specific adapter 606 translates the copy request to a vendor specific command (step 8). The storage system 607 starts copying the contents written in those used block lists (step 9). After the completion of the copy process, the storage system 607 notifies the vendor specific adapter 606 about the completion of the copy operation (step 10). The vendor specific adapter 606 informs the storage system adapter 605 about the completion of the copy operation (step 11). Thereafter, the entire process of the copy process is completed by notifying the copy manager 602, application adapter layer 603 and the application specific adapter 604 about the completion of the copy process.

Thus the present invention provides a list containing the addresses of the blocks within the source volume that are occupied by some data, and sends a copy request along with this list to a target storage system. The storage system copies the data blocks that are used by the target volume thereby reducing the time consumed by the overall copy process. Further, the internal bandwidth of the storage system, SAN bandwidth and storage system resource is also saved. Since the time involved in overall copy operation is reduced, hence, application availability is increased and the IO performances of the storage system are improved. Furthermore, ‘copying nothing to nothing’ is also eliminated.

While the present invention has been described with reference to certain exemplary embodiments, those skilled in the art will recognize that various modifications may be provided. Accordingly, the scope of the invention is to be limited only by the following claims.

We claim:

1. A method for copying data from a source volume to a target volume, the method comprising:
maintaining a list of used data blocks within the source volume;
receiving a request to copy data from the source volume to the target volume;
forwarding the request to an application specific adapter associated with the source volume;
identifying a first plurality of used data blocks within the source volume, which are associated with the copy request, by analyzing the list of used data blocks; and
copying the first plurality of used data blocks from the source volume to the target volume.

2. The method of claim 1 wherein the source volume and the target volume are communicatively coupled by a storage area network.

3. The method of claim 1 wherein the list of unused data blocks is maintained using a plurality of logical block addresses and corresponding plurality of data lengths.

4. The method of claim 1 wherein the list of unused data blocks is maintained within a storage bitmap.

5. The method of claim 4 wherein the storage bitmap contains first identifiers representing used data locations and second identifiers representing unused data locations.

6. The method of claim 1 further comprising the steps of:
preventing read and write commands from executing in the source volume after receiving the request to copy data; and
allowing the read and write commands to begin executing after copying the first plurality of used data blocks from the source volume to the target volume.

7. The method of claim 6 wherein an application specific adapter, associated with the source volume, prevents and allow execution of read and write commands.

8. A storage system application adapter that controls a copy operation from a source volume to a target volume, the adapter comprising:
a processor, coupled within the adapter, that receives a copy request and initiates a copy operation;
a source target volume identifier, coupled to the processor, that identifies a storage location within the source volume, which is associated with the copy request; and
a used block list, coupled to the processor, that identifies a block topology within the source volume so that unused data blocks may be identified and prevented from being copied to the target volume.

9. The adapter of claim 8 further comprising a data block bitmap that comprises a plurality of first identifiers that represent unused data blocks and a plurality of second identifiers that represent used data blocks.

10. The adapter of claim 9 wherein the plurality of first identifiers are a logical one and the plurality of second identifiers are a logical zero.

11. The adapter of claim 8 wherein used block within the source volume are identified by a plurality of logical block addresses and corresponding data lengths.

12. The adapter of claim 8 wherein the adapter functions within a storage area network.

13. The adapter of claim 8 wherein the adapter prevents read and write operations on the source volume from executing in response to receiving the copy request.

14. The adapter of claim 13 wherein the adapter allows the read and write operations on the source volume to execute in response to completing the copy request.

15. The adapter of claim 8 wherein the adapter flushes an application's operating system cache buffers in response to receiving the copy request.

16. A storage system that copies data from a source volume to a target volume, the system comprising;
a copy manager that is coupled to receive copy requests from a host system external to the storage system;
an application layer that processes commands related to a plurality of storage disks within the storage systems and coupled to receive a copy request;
at least one application specific adapter, coupled to receive the copy request and control a copy operation, across a plurality of storage disks within the storage system; and
wherein the at least one application specific adapter identifies used blocks within storage locations in the source volume that are associated with the copy request and causes only those used blocks to be copied to a target location.

17. The system of claim 16 wherein the source volume and the target volume are communicatively coupled by a storage area network.

18. The system of claim 16 wherein the at least one application specific adapter comprises a block topology of the source volume that identifies used blocks therein.

19. The system of claim 18 wherein the block topology is maintained as a plurality of logical block addresses and corresponding plurality of data lengths.

20. The system of claim 18 wherein the block topology comprises a bitmap of the source volume in which used blocks are identified by a plurality of logical values.
